(19) United States
(12) Patent Application Publication
(10) Pub. No.: US 2002/0196485 A1
(43) Pub. Date: Dec. 26, 2002

(54) Image forming apparatus

(75) Inventors: Yukihiro Mizoguchi, Tokyo (JP); Toshiharu Takahashi, Tokyo (JP); Masaru Matsunami, Yokohama-shi (JP); Miki Konno, Kawasaki-shi (JP)

Correspondence Address: Johnny A. Kumar, FOLEY & LARDNER, Washington Harbour, 3000 K Street, N.W., Suite 500, Washington, DC, 20007-5109, US

(73) Assignee: TOSHIBA TEC KABUSHIKI KAISHA

(21) Appl. No.: 09/773,532

(22) Filed: Jun. 25, 2001

(51) Int. Cl. H04N 1/46

(52) U.S. Cl. 358/537

(57) ABSTRACT

When a digital copying machine is switched on, a main CPU confirms whether the current timing is a timing at which an advertisement can be displayed on a display section. If operational inputs are being performed from the display section in the digital copying machine, the advertisement cannot be displayed and thus a normal image forming operation is controlled. If operational inputs are not being performed from the display section and the current timing is the timing at which the advertisement can be displayed, it is conformed whether an HDD stores a registered image as an advertisement image. If there is at least one registered image in the HDD, the at least one registered image is displayed on the display section at predetermined time intervals at the timing of the advertisement display in accordance with the priority level. The registered image in the HDD, whose remaining designated display time has reduced to zero, is deleted.

### BACKGROUND OF THE INVENTION

The present invention relates to an image forming apparatus such as a digital copying machine wherein a user wishing advertising is able to register an advertisement and to display it on a control panel.

In a conventional image forming apparatus such as a digital copying machine, an image of an original input by an image reading section is subjected to predetermined image processing and the image of the original is output from an output section, or image information edited by an external device such as a personal computer is received and the image information is output. Recently, a multi-functional apparatus with many editing functions is known, which is able to subject an image of an original to predetermined processing to change it to an expressive one or to edit plural images at a time.

Jpn. Pat. Appln. KOKAI Publication No. 11-355549, for instance, discloses a technique with a mode in which the above-mentioned functions are utilized and advertisement image information registered in advance in a copying machine by a dealer and original image information of an original set on the copying machine are combined and recorded on a sheet.

On the other hand, Jpn. Pat. Appln. KOKAI Publication No. 2000-59554 discloses a technique wherein a public telephone network and a copying machine are connected, information such as advertisements and news, which is supplied via the public telephone network, is periodically provided to the copying machine, and such information is displayed on the operation panel while copying operations are being performed. The public telephone network may be one used as a line for maintenance (maintenance line).

As has been described above, although there is a conventional technique wherein advertisement image information is registered in advance by a dealer, there is no technique wherein a user wishing advertising, such as an advertisement provider or an advertisement orderer, directly registers advertisements or messages. Besides, although there is a conventional technique wherein advertisements are supplied to an image forming apparatus via a public telephone network, there is no technique wherein an advertisement original in the form of a document (sheet) is directly registered to an installed image forming apparatus and an advertisement is displayed.

### BRIEF SUMMARY OF THE INVENTION

The object of the present invention is to provide an image forming apparatus wherein a user wishing advertising can directly register an advertisement original and displays an advertisement, and also a user can register and display a message.

In order to achieve the object, the present invention provides an image forming apparatus for forming an image by controlling an image forming operation, the apparatus comprising: a display for displaying information; an operation panel for setting image registration for displaying an advertisement on the display; a scanner for reading an advertisement original to be registered, when the image registration has been set by the operation panel; a registration section for registering an image of the advertisement original read by the scanner; and a control section for performing a control for displaying on the display the image registered in the registration section.

This invention also provides an image forming apparatus for forming an image by controlling an image forming operation, the apparatus comprising: a display for displaying information; a first setting section for setting image registration for displaying an advertisement on the display; a scanner for reading an advertisement original to be registered, when the image registration has been set by the first setting section; a first registration section for registering an image of the advertisement original read by the scanner; a second setting section for setting addition of a description to the image registered by the first registration section; an input section for inputting the description when the addition of the description has been set by the second setting section; a second registration section for adding the description input by the input section to the image registered in the first registration section, and registering the resultant image; and a control section for performing a control for displaying on the display the registered image and description after the image with the added description has been registered in the second registration section.

This invention also provides an image forming apparatus for forming an image by controlling an image forming operation, the apparatus comprising: a display for displaying information; an operation panel for setting registration for displaying a message on the display; an input section for inputting a message to be registered, when the registration for displaying the message has been set by the operation panel; a registration section for registering the message input by the input section; and a control section for performing a control for displaying on the display the message registered in the registration section.

### BRIEF DESCRIPTION OF SEVERAL VIEWS OF THE DRAWING

FIG. 1 is a cross-sectional view schematically showing an internal structure of a digital copying machine as an example of an image forming apparatus according to the present invention;

FIG. 2 shows a structure of an operation panel;

FIG. 3 is a block diagram schematically showing electrical connection of the digital copying machine shown in FIG. 1 and flow of signals for control;

FIG. 4 shows an example of display of an advertisement image on an entire surface of a display section of an operation panel;

FIG. 5 shows an example of display of an advertisement image on an advertisement area provided on a portion of the display section of the operation panel;

FIG. 6 is a flow chart illustrating an operation for registering an advertisement in the digital copying machine;

FIG. 7 shows an example of display on a setting screen;

FIG. 8 is a flow chart illustrating a display operation for displaying a registered image as an advertisement image in the digital copying machine;

FIG. 9 is a flow chart illustrating an operation for registering a message in the digital copying machine;

FIG. 10 shows an example of a menu screen displayed on the display section of the operation panel when message registration has been selected;

FIG. 11 is a flow chart illustrating an operation for reading a message from the digital copying machine; and

FIG. 12 shows an example of the menu screen displayed on the display section of the operation panel when message read has been selected.

### DETAILED DESCRIPTION OF THE INVENTION

An embodiment of the present invention will now be described with reference to the accompanying drawings.

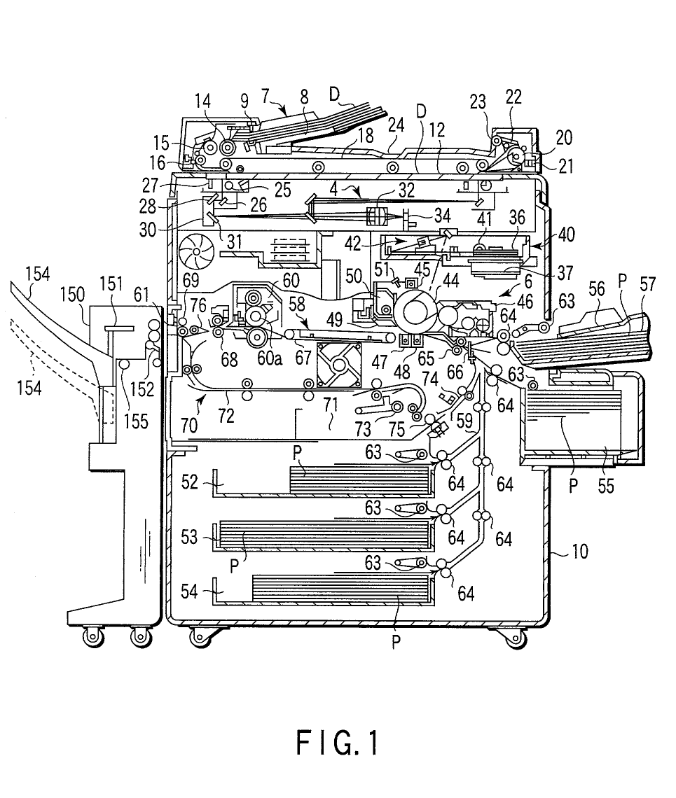

FIG. 1 is a cross-sectional view showing an internal structure of a digital copying machine as an example of an image forming apparatus according to the present invention.

As is shown in FIG. 1, the digital copying machine comprises an apparatus main body 10. The apparatus main body 10 incorporates a scanner section 4 functioning as an image read means and a printer section 6 functioning as an image forming means.

An original table 12 formed of transparent glass, on which a read object, i.e. an original D is placed, is disposed on the upper surface of the apparatus main body 10. An automatic document feeder 7 (hereinafter referred to as “ADF”) for automatically feeding originals onto the original table 12 is disposed on the upper surface of the apparatus main body 10. The ADF 7 is disposed to be opened/closed with respect to the original table 12 and serves as an original holder for bringing the original D placed on the original table 12 into close contact with the original table 12.

The ADF 7 has an original tray 8 on which the original D is set; an empty sensor 9 for detecting the presence/absence of originals; pickup rollers 14 for picking up originals on the original tray 8 one by one; a feed roller 15 for conveying the picked-up original; an aligning roller pair 16 for aligning the leading edges of the originals; and a conveyor belt 18 disposed to cover almost the entire surface of the original table 12. A plurality of originals set on the original tray 8 with their surfaces facing up are sequentially taken out from the lowermost page, i.e. the last page, aligned by the aligning roller pair 16, and conveyed to a predetermined position on the original table 12 by the conveyor belt 18.

In the ADF 7, a reversing roller 20, a non-reverse sensor 21, a flapper 22 and a delivery roller 23 are disposed at the end portion on the opposite side of the aligning roller pair 16 with respect to the conveyor belt 18. The original D whose image information has been read by the scanner section 4 (to be described later) is fed from the original table 12 by the conveyor belt 18 and delivered to an original delivery section 24 on the ADF 7 through the reversing roller 20, flapper 21 and delivery roller 22. To read the lower surface of the original D, the flapper 22 is switched. The original D conveyed by the conveyor belt 18 is reversed by the reversing roller 20 and fed to a predetermined position on the original table 12 again by the conveyor belt 18.

The scanner section 4 provided in the apparatus main body 10 has an exposure lamp 25 as a light source for illuminating the original D placed on the original table 12, and a first mirror 26 for deflecting reflection light from the original D in a predetermined direction. The exposure lamp 25 and first mirror 26 are attached to a first carriage 27 disposed under the original table 12.

The first carriage 27 is disposed to be movable in parallel to the original table 12 and reciprocally moved under the original table 12 by a driving motor through a toothed belt (not shown), etc.

A second carriage 28 movable in parallel to the original table 12 is disposed under the original table 12. Second and third mirrors 30 and 31 for successively deflecting reflection light from the original D, which has been deflected by the first mirror 26, are attached to the second carriage 28 at right angels with each other. The second carriage 28 is moved by, e.g. the toothed belt for driving the first carriage 27 along with the first carriage 27, and moved in parallel along the original table 12 at half the speed of the first carriage.

A focusing lens 32 for focusing reflection light from the third mirror 31 mounted on the second carriage 28, and a CCD sensor 34 serving as photoelectric conversion means for receiving the reflected light focused by the focusing lens and photoelectrically converting it are disposed under the original table 12. The focusing lens 32 is disposed in a plane including the optical axis of the light deflected by the third mirror 31 so as to be movable by means of a driving mechanism. The focusing lens 32 moves to focus the reflection light at a desired magnification. The line sensor 34 photoelectrically converts the incoming reflection light and outputs an electrical signal corresponding to the read original D.

On the other hand, the printer section 6 has a laser exposure unit 40 functioning as a latent image forming means. The laser exposure unit 40 comprises a semiconductor laser 41 as a light source; a polygon mirror 36 as a scanning member for continuously deflecting a laser beam emitted by the semiconductor laser 41; a polygon motor 37 as a scanning motor for rotatably driving the polygon mirror 36 at a predetermined rotational speed (to be described later); and an optical system 42 for deflecting the laser beam from the polygon mirror 36 and guiding the beam to a photosensitive drum 44 (to be described later). The laser exposure unit 40 with the above structure is fixed to a support frame (not shown) of the apparatus main body 10.

The semiconductor laser 41 is ON/OFF-controlled in accordance with the image information of the original D read by the scanner section 4 or facsimile transmission/reception document information. The laser beam is directed to the photosensitive drum 44 through the polygon mirror 36 and optical system 42 to scan the outer surface of the photosensitive drum 44, thereby forming an electrostatic latent image on the outer peripheral surface of the photosensitive drum 44.

The printer section 6 has the rotatable photosensitive drum 44 as an image carrier disposed almost at the center of the apparatus main body 10. The outer peripheral surface of the photosensitive drum 44 is exposed to the laser beam from the laser exposure unit 40, and so a desired electrostatic latent image is formed thereon. Around the photosensitive drum 44, the following elements are arranged in the named order: a charger 45 for electrifying the outer peripheral surface of the drum 44 with a predetermined charge; a developing device 46 for supplying toner as a developer to the electrostatic latent image formed on the outer peripheral surface of the photosensitive drum 44 to develop it at a desired image density; a separation charger 47 for separating an image formation medium, i.e. a paper sheet P, fed from a paper cassette (to be described later) from the photosensitive drum 44; a transfer charger 48 for transferring the toner image formed on the photosensitive drum 44 onto the paper sheet P; a separation gripper 49 for separating the paper sheet P from the outer peripheral surface of the photosensitive drum 44; a cleaning unit 50 for removing toner remaining on the outer peripheral surface of the photosensitive drum 44; and a discharger 51 for de-electrifying the outer peripheral surface of the photosensitive drum 44.

An upper sheet cassette 52, a middle sheet cassette 53 and a lower sheet cassette 54 which can be drawn out of the apparatus main body are stacked at the lower portion of the apparatus main body 10. These cassettes 52 to 54 store paper sheets P of different sizes. A large-capacity feeder 55 is disposed on one side of these cassettes. This large-capacity feeder 55 stores about 3,000 paper sheets P having a size with high use frequency, e.g. paper sheets P with A4 size. A feed cassette 57 also serving as a manual feed tray 56 is detachably attached above the large-capacity feeder 55.

A convey path 58 extending from the sheet cassettes and large-capacity feeder 55 through a transfer section located between the photosensitive drum 44 and transfer charger 48 is formed in the apparatus main body 10. A fixing unit 60 having a fixing lamp 60a is disposed at the end of the convey path 58. A delivery port 61 is formed in the side wall of the apparatus main body 10, which is opposed to the fixing unit 60. A single-tray finisher 150 is attached to the delivery port 61.

Pickup rollers 63 for taking out the paper sheets P one by one from the sheet cassette or large-capacity feeder 55 are arranged near each of the upper sheet cassette 52, middle sheet cassette 53, lower sheet cassette 54 and feed cassette 57 and near the large-capacity feeder 55. A number of feed roller pairs 64 for conveying the paper sheet P taken out by the pickup rollers 63 through the convey path 58 are arranged in the convey path 58.

A registration roller pair 65 is arranged in the convey path 58 on the upstream side of the photosensitive drum 44. The registration roller pair 65 corrects a tilt of the extracted paper sheet P, registers the leading edge of the toner image on the photosensitive drum 44 and the leading edge of the paper sheet P, and feeds the paper sheet P to the transfer section at the same speed as the speed of movement of the outer peripheral surface of the photosensitive drum 44. A prealigning sensor 66 for detecting arrival of the paper sheet P is provided in front of the registration roller pair 65, i.e. on the feed roller 64 side.

Each paper sheet P extracted one by one from the sheet cassette or large-capacity feeder 55 by the pickup rollers 63 is fed to the registration roller pair 65 by the feed roller pair 64. After the leading edge of the paper sheet P is aligned by the registration roller pair 65, the paper sheet P is fed to the transfer section.

In the transfer section, a developer image, i.e. toner image formed on the photosensitive drum 44 is transferred onto the paper sheet P by the transfer charger 48. The paper sheet P on which the toner image has been transferred is separated from the outer peripheral surface of the photosensitive drum 44 by the function of the separation charger 47 and separation gripper 49 and conveyed to the fixing unit 60 through a conveyor belt 67 constituting part of the convey path 52. After the developer image is melted and fixed on the paper sheet P by the fixing unit 60, the paper sheet P is delivered onto the finisher 150 through the delivery port 61 by a feed roller pair 68 and a delivery roller pair 69.

An automatic double-side unit 70 for reversing the paper sheet P which has passed through the fixing unit 60 and feeding it to the registration roller pair 65 again is provided under the convey path 58. The automatic double-side unit 70 comprises a temporary stack section 71 for temporarily stacking the paper sheets P; a reversing path 72 branched from the convey path 58 to reverse the paper sheet P which has passed through the fixing unit 60 and to guide the paper sheet P to the temporary stack 71; pickup rollers 73 for extracting the paper sheets P stacked on the temporary stack section 71 one by one; and a feed roller 75 for feeding the extracted paper sheet P to the registration roller pair 65 through a convey path 74. A selector gate 76 for selectively distributing the paper sheets P to the delivery port 61 or reversing path 72 is provided at the branch portion between the convey path 58 and reversing path 72.

Where double-copying is performed, the paper sheet P which has passed through the fixing unit 60 is guided to the reversing path 72 by the selector gate 76, temporarily stacked on the temporary stack section 71 in a reversed state, and fed to the registration roller pair 65 through the convey path 74 by the pickup rollers 73 and feed roller 75. The paper sheet P is registered by the registration roller pair 65 and fed to the transfer section again to transfer a toner image onto the reverse surface of the paper sheet P. Thereafter, the paper sheet P is delivered to the finisher 150 through the convey path 58, fixing unit 60 and delivery rollers 69.

The finisher 150 staples delivered copies of documents and stores them in units of a copy. Each time a paper sheet P to be stapled has been delivered from the delivery port 61, a guide bar 151 aligns the paper sheet P to the stapling side. When all paper sheets have been delivered, a copy of paper sheets P is pressed by a paper press arm 152 and stapled by a stapler unit (not shown). Then the guide bar 151 moves downward. The stapled paper sheets P are delivered to a finisher delivery tray 154 by a finisher delivery roller 155 in units of a copy. The downward movement amount of the finisher delivery tray 154 is roughly determined in accordance with the number of paper sheets P to be delivered, and the finisher delivery tray 154 moves downward stepwise every time one copy is delivered. The guide bar 151 for aligning the delivered paper sheets P is located at such a high position that the guide bar 151 may not abut upon the already stapled paper sheets P placed on the finisher delivery tray 154.

The finisher delivery tray 154 is connected to a shift mechanism (not shown) which shifts (e.g. in four directions: front, rear, left and right sides) in units of a copy in the sort mode.

An operation panel 80 (not shown) for inputting various copy conditions and a copy start signal for starting copying operations is provided at the upper portion on the front side of the apparatus main body 10.

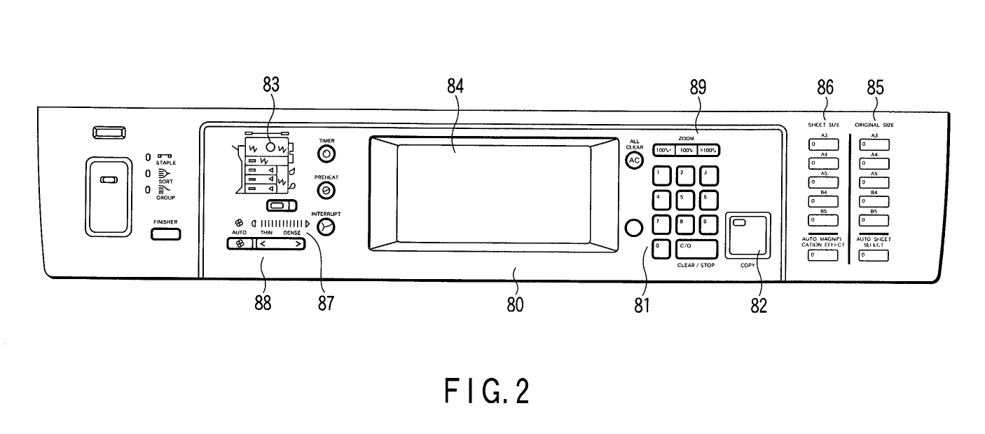

As is shown in FIG. 2, the operation panel 80 comprises ten-keys 81, a copy key 82, a state display section 83, a liquid crystal display section 84, original size setting keys 85, sheet size setting keys 86, a density display section 87, density setting keys 88 and magnification setting keys 89.

The ten-keys 81 are used to set the number of originals and the number of copies.

The copy key 82 is used to instruct start of copying.

The state display section 83 displays guidance information such as the selected sheet cassette, jamming of originals or sheets, etc.

The display section 84 displays the number of originals and the number of copies, as well as operational information on copying magnification, editing, etc. The liquid crystal display section 84 is provided with a touch panel for inputting operational instructions, e.g. inputting through select keys. For example, select keys for original modes including a photograph mode, a character mode and a character/photograph mode are displayed for inputting.

The original size setting keys 85 are used to set the size of the original D.

The sheet size setting keys 86 are used to set the size of the sheet P.

The density display section 87 displays a copying density set by the density setting keys 88.

The magnification setting keys 89 are used to set the copying magnification.

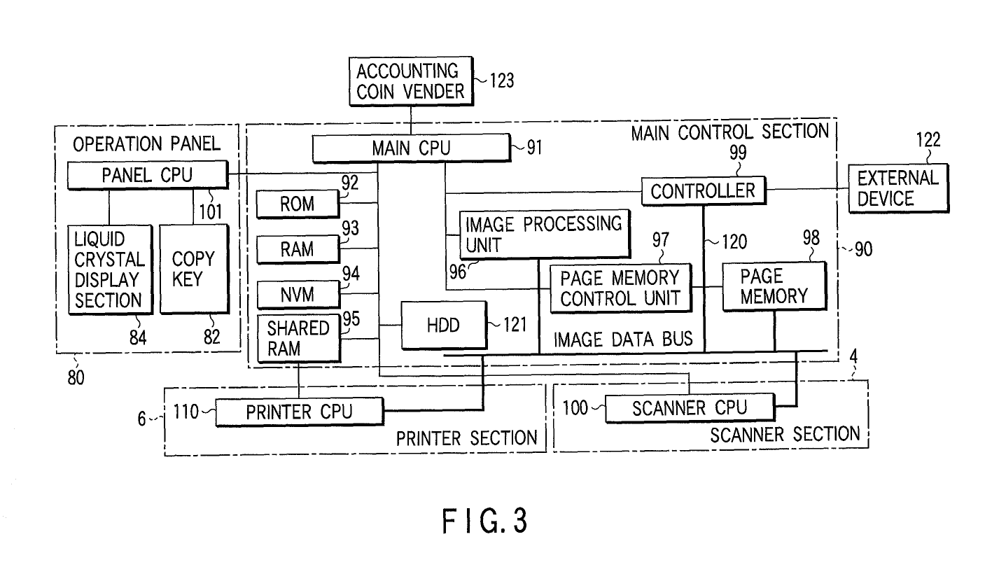

FIG. 3 is a block diagram schematically showing electrical connection of the digital copying machine shown in FIG. 1 and flow of signals for control. In FIG. 3, the digital copying machine has three CPUs: a main CPU 91 provided in a main control section 90; a scanner CPU 100 in the scanner section 4; and a printer CPU 110 in the printer section 6. The main CPU 91 performs bi-directional communication with the printer CPU 110 via a shared RAM 95. The main CPU 91 issues an operational instruction, and the printer CPU 110 returns status data. Serial communication is performed between the printer CPU 110 and scanner CPU 100. The printer CPU 110 issues an operational instruction, and the scanner CPU 100 returns status data.

The operation panel 80 is connected to the main CPU 91.

The main control section 90 comprises the main CPU 91, a ROM 92, a RAM 93, an NVM 94, shared RAM 95, an image processing unit 96, a page memory control unit 97, a page memory 98, a data controller 99 and a hard disk drive (HDD) 121.

The main CPU 91 controls the entirety of the main control section 90. The ROM 92 stores control programs. The RAM 93 temporarily stores data.

The NVM (Non-Volatile RAM) 94 is a non-volatile memory backed up by a battery (not shown). Even when power is not supplied to the NVRAM 34, stored data is maintained.

The shared RAM 95 is used to perform bi-directional communication between the main CPU 91 and printer CPU 110.

The page memory control unit 97 stores and reads out image information in and from the page memory 98. The page memory 98 has areas capable of storing image information of a plurality of pages. The page memory 98 can store compressed data in units of a page, which is obtained by compressing image information from the scanner section 4.

The data controller 99 controls data from an external device 122 such as a personal computer.

The hard disk drive 121 stores advertisement images, messages, etc. to be registered.

An accounting coin vender 123 is connected to the main CPU 91, as will be described later in detail.

Advertisement display on the digital copying machine of the present invention having the above structure will now be described. Assume that the digital copying machine of this invention is used in a convenience store, etc. The digital copying machine of this invention placed in the convenience store displays advertisements on the display section 84 of the operational panel 80 when the digital copying machine is not used.

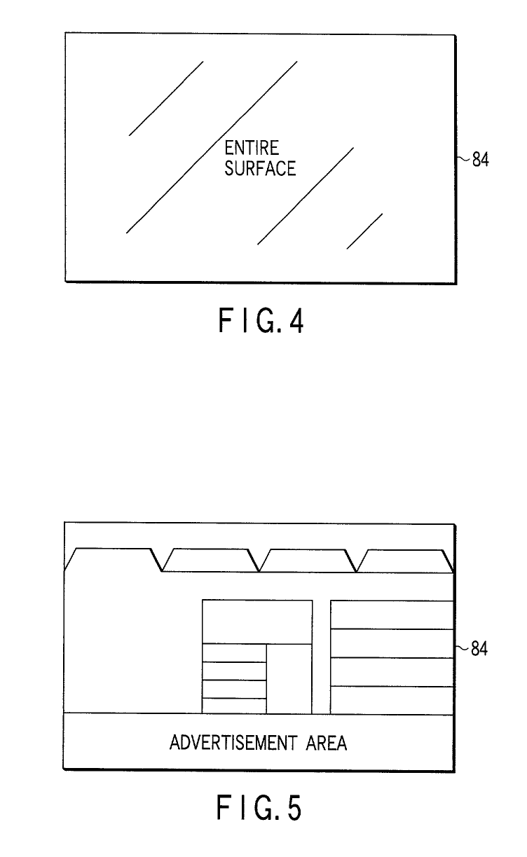

FIG. 4 shows an example of display of an advertisement image, which is saved in the HDD 121 by the main CPU 91, on the entire surface of the display section 84 of the operation panel 80.

FIG. 5 shows an example of display of an advertisement image, which is saved in the HDD 121 by the main CPU 91, on an advertisement area provided on a portion of the display section 84 of the operation panel 80.

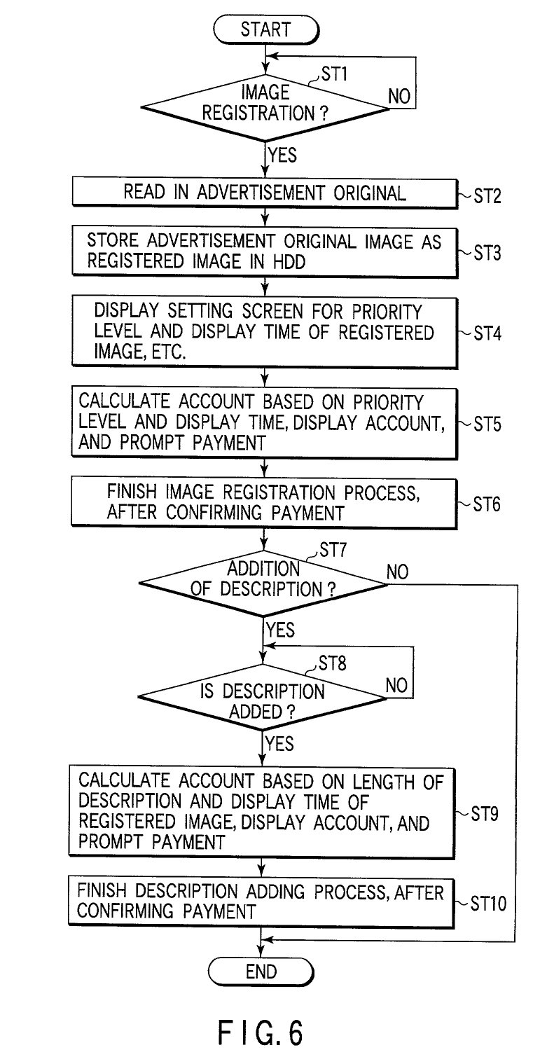

An operation in which a user registers an advertisement in the digital copying machine of this invention will now be described with reference to a flow chart of FIG. 6.

To begin with, the user who wishes to register an advertisement in the digital copying machine prepares an original for the advertisement. The user selects a [SPECIAL] key on the menu screen displayed on the display section 84 of the operation panel 80 and selects “IMAGE REGISTRATION” (ST1). Then, the advertisement original to be displayed is read in the digital copying machine (ST2).

Based on the job of the selected “IMAGE REGISTRATION”, the main CPU 91 saves the image of the advertisement original, which was read in by the scanner section 4, in the HDD 121 as the registered image (ST3).

The main CPU 91 displays on the display section 84 a setting screen for a priority level (e.g. numerals 1-5) of the registered image, a display time (e.g. 23 h. 59 min. 59 sec. at maximum), etc. (ST4). The higher the numeral of priority level, the higher the fee.

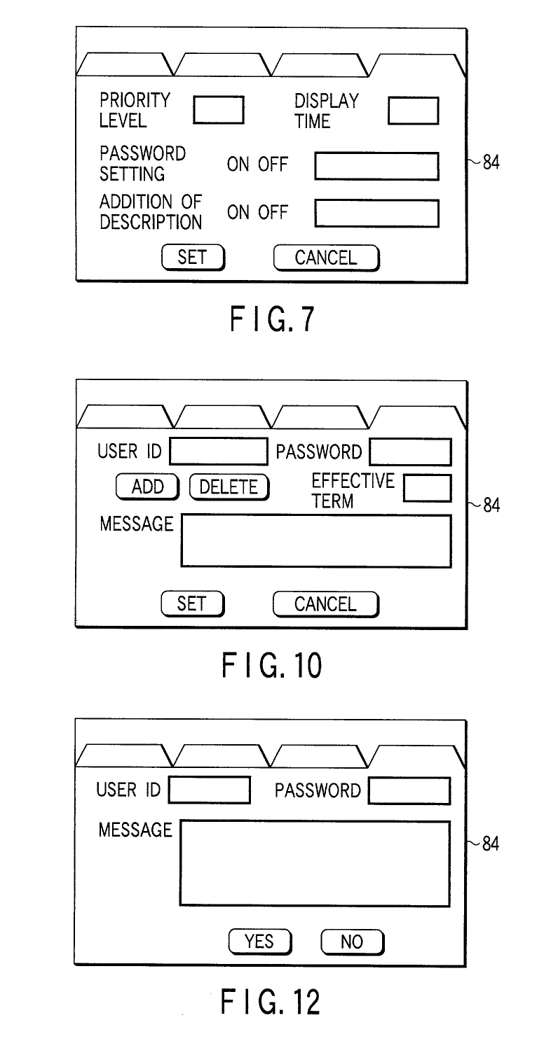

FIG. 7 shows an example of display on the setting screen. The display section 84, as shown in FIG. 7, displays the screen for setting the priority level, display time, ON/OFF of password setting, ON/OFF of addition of description, [SETTING] key, [CANCEL] key, etc.

On the screen, the user sets the priority level, display time, and ON/OFF of password setting.

The main CPU 91 calculates an account in proportion to the set priority level and display time, displays the calculated account on the display section, and prompts the user to pay the account from the accounting coin vender 123 (ST5). After confirming the payment from the accounting coin vender 123, the main CPU 91 saves the registered image with the setting information in the HDD 121, and completes the image registration process (ST6).

An optional function for adding a description to the advertisement is provided.

The user turns on the setting of addition of description on the setting screen shown in FIG. 7 (ST7) and inputs a description. The description is input by a Japanese-character-input/Chinese-character-conversion method, like facsimiles, etc.

When the description has been input (ST8), the main CPU 91 calculates an account on the basis of the length of the description and the display time of the registered image (e.g. 100 yen if the length of description is 1 KB and the display time is one hour), displays the account on the display section 84, and prompts the user to pay the account from the accounting coin vender 123 (ST9). After confirming the payment from the accounting coin vender 123, the main CPU 91 saves the registered image with the description in the HDD 121, and completes the description adding process (ST10).

The method of accounting may be of a prepaid system, or the remaining time may be displayed in relation to cash paid by a registered user.

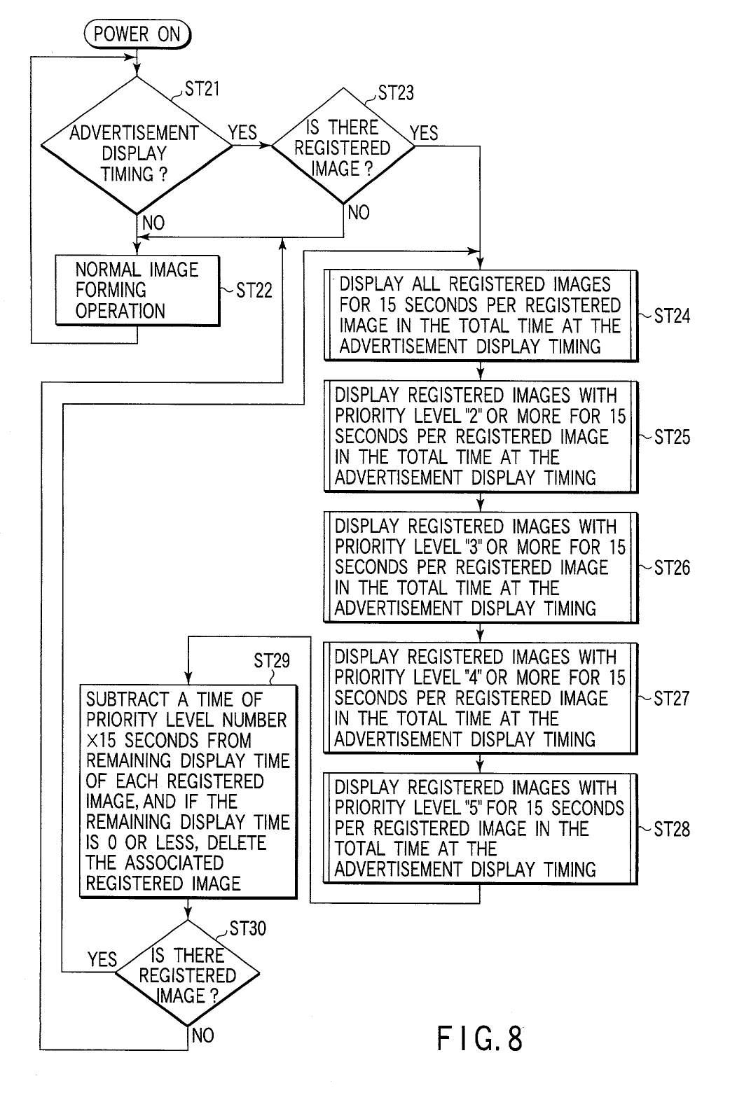

Referring to a flow chart of FIG. 8, a description will now be given of a display operation for displaying a registered image as an advertisement image in the digital copying machine.

When the digital copying machine is switched on, the main CPU 91 confirms whether the present timing is a timing at which advertisements can be displayed on the display section 84 (ST21). If operational inputs are being performed from the display section 84 in the digital copying machine, display of advertisements cannot be effected. Thus, a normal operation for forming images is controlled (ST22).

In step ST21, when the operational inputs are not being performed from the display section 84 (i.e. at the advertisement display timing), the main CPU 91 confirms whether a registered image as an advertisement image is saved in the HDD 121 (ST23). If there is no registered image, the normal operation for image formation is controlled (ST22).

If it is confirmed in step ST23 that there are registered images, the main CPU 91 displays all registered images saved in the HDD 121 on the display section 84 for 15 seconds per registered image in the total time at the advertisement display timing, that is, in the total time period in which advertisement display is permitted (ST24).

Following the display in step ST24, the main CPU 91 displays the registered images with the priority level “2” or more saved in the HDD 121 on the display section 84 for 15 seconds per registered image in the total time at the advertisement display timing (ST25).

Following the display in step ST25, the main CPU 91 displays the registered images with the priority level “3” or more saved in the HDD 121 on the display section 84 for 15 seconds per registered image in the total time at the advertisement display timing (ST26).

Following the display in step ST26, the main CPU 91 displays the registered images with the priority level “4” or more saved in the HDD 121 on the display section 84 for 15 seconds per registered image in the total time at the advertisement display timing (ST27).

Following the display in step ST27, the main CPU 91 displays the registered images with the priority level “5” saved in the HDD 121 on the display section 84 for 15 seconds per registered image in the total time at the advertisement display timing (ST28).

Subsequent to the display in step ST28, the main CPU 91 subtracts a time of the priority level number×15 seconds from the remaining display time of each registered image stored in the HDD 121. If the remaining display time is 0 or less, the associated registered image is deleted (ST29).

After the registered image is deleted in step ST29, the main CPU 91 confirms whether there remain other registered images in the HDD 121 (ST30). If there are other registered images, the control for displaying them on the display section 84 is repeated in step ST24. If there is no registered image, control goes to step ST22.

If the advertisement display timing has ended, the display control by the main CPU 91 in steps ST24 to ST28 is immediately stopped and control goes to step ST22. If the advertisement display timing occurs again, the display control is resumed.

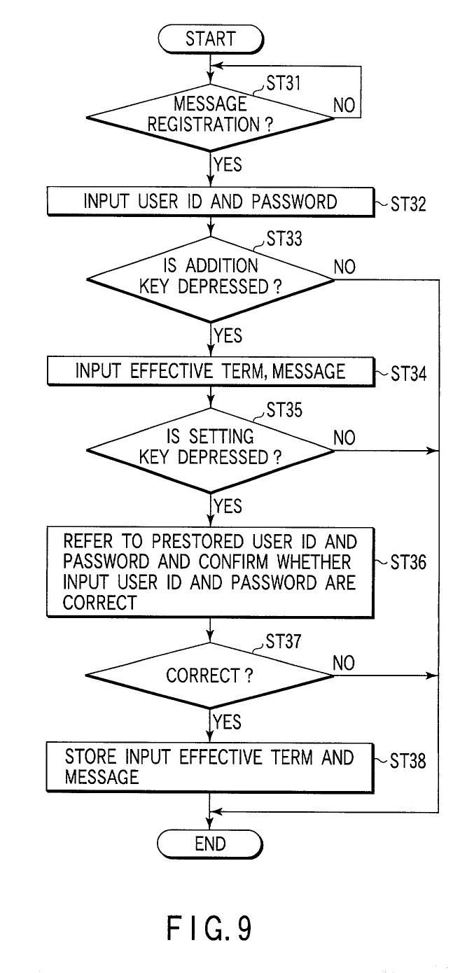

An operation in which the user registers a message in the digital copying machine of this invention will now be described with reference to a flow chart of FIG. 9.

Assume that the digital copying machine is used in a convenience store, etc.

The user wishing registration of a message in the digital copying machine selects the [SPECIAL] key on the menu screen displayed on the display section 84 of the operation panel 80 and selects “MESSAGE REGISTRATION” (ST31). The main CPU 91 displays a menu screen for message registration on the display section 84 of the operation panel 80.

FIG. 10 shows an example of the menu screen displayed on the display section 84 of the operation panel 80 when the message registration is selected. On the message registration menu screen, the user inputs pre-registered user ID and password (ST32). Then, the user selects an [ADDITION] key or a [DELETE] key.

After depressing the [ADDITION] key (ST33), the user inputs an effective term and a message (ST34). Then, the user depresses a [SETTING] key to effect setting. If a [CANCEL] key is depressed, the setting is canceled.

When the [SETTING] key has been depressed (ST35), the main CPU 91 refers to a user ID and password pre-stored in the HDD 121 and verifies whether the input user ID and password are correct (ST36). If they are correct (ST37), the main CPU 91 saves the input effective term and message in the HDD 121 in association with the user ID (ST38).

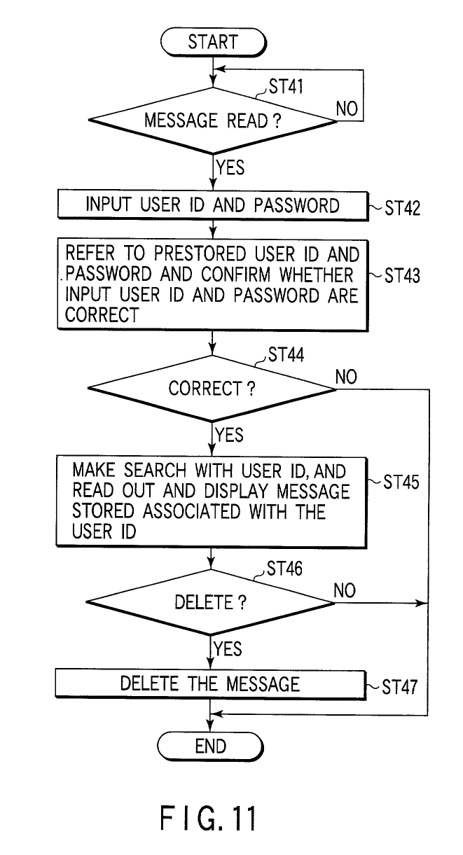

An operation in which a user reads a message from the digital copying machine of this invention will now be described with reference to a flow chart of FIG. 11.

A user who will read the message registered in the digital copying machine selects the [SPECIAL] key on the menu screen displayed on the display section 84 of the operation panel 80 and selects “MESSAGE READ” (ST41). The main CPU 91 shows a menu screen for message reading on the display section 84 of the operation panel 80.

FIG. 12 shows an example of the menu screen displayed on the display section 84 of the operation panel 80 when the message read has been selected. On the message read menu screen, the user inputs the user ID and password (ST42).

The main CPU 91 refers to a user ID and password prestored in the HDD 121 and verifies whether the input user ID and password are correct (ST43). If they are correct (ST44), the main CPU 91 searches the HDD 121 with the user ID, and reads out and displays the message associated with the user ID (step ST45).

After reading the message, the user selectively depresses a “YES” key or a “NO” key to determine whether or not to delete the message (ST46).

If the “YES” key is depressed, the main CPU 91 deletes the message in the HDD 121 and completes the message read process (ST47). If the “NO” key is depressed, the main CPU 91 completes the message read process.

The main CPU 91 deletes messages whose effective terms have expired from the HDD 121.

As has been described above, according to the embodiment of the present invention, the image forming apparatus such as a digital copying machine installed in the convenience store, etc. can be used for area-specific advertisements, messages among friends, and advertisements for customers.

What is claimed is:

1. An image forming apparatus for forming an image by controlling an image forming operation, the apparatus comprising:
a display for displaying information;
an operation panel for setting image registration for displaying an advertisement on the display;
a scanner for reading an advertisement original to be registered, when the image registration has been set by the operation panel;
a registration section for registering an image of the advertisement original read by the scanner; and
a control section for performing a control for displaying on the display the image registered in the registration section.

2. An image forming apparatus according to claim 1, wherein the setting on the operation panel is effected by a touch panel provided on the display.

3. An image forming apparatus according to claim 1, wherein the registration section registers the image of the advertisement original in a hard disk drive.

4. An image forming apparatus according to claim 1, wherein the control section performs a control for displaying all registered images registered in the registration section on a portion of the display in a predetermined order.

5. An image forming apparatus according to claim 1, wherein the control section controls, if information for setting the image forming operation is being displayed on the display, the image forming operation during this time period as a timing at which advertisement display is prohibited, and the control section performs, if information for setting the image forming operation is not displayed on the display, the control for displaying on the display all registered images registered in the registration section during this time period as a timing at which advertisement display is permitted.

6. An image forming apparatus according to claim 5, wherein the control section performs the control for displaying all registered images registered in the registration section on the display in a predetermined order at predetermined time intervals at the timing at which the advertisement display is permitted.

7. An image forming apparatus according to claim 1, wherein the registration section includes an input section for inputting an advertisement time and a priority level of the image to be registered, and an accounting process section for performing an accounting process in accordance with the advertisement time and priority level input by the input section.

8. An image forming apparatus according to claim 5 or 7, wherein the control section performs the control for displaying all registered images registered in the registration section on the display at predetermined time intervals at the timing at which the advertisement display is permitted, in accordance with the priority level input by the input section.

9. An image forming apparatus according to claim 1 or 7, wherein the control section performs the control for displaying at least one image, for which the accounting process has been performed by the accounting process section, in accordance with the advertisement time and priority level of the image.

10. An image forming apparatus according to claim 1, wherein the control section includes a switch-display section for displaying at least one image registered in the registration section in a switched manner at predetermined time intervals, and a finishing section for finishing the display of the image when a total display time of the image displayed by the switch-display section has reached an advertisement time of the image.

11. An image forming apparatus according to claim 10, wherein the finishing section deletes the image from the registration section.

12. An image forming apparatus for forming an image by controlling an image forming operation, the apparatus comprising:
a display for displaying information;
a first setting section for setting image registration for displaying an advertisement on the display;
a scanner for reading an advertisement original to be registered, when the image registration has been set by the first setting section;
a first registration section for registering an image of the advertisement original read by the scanner;
a second setting section for setting addition of a description to the image registered by the first registration section;
an input section for inputting the description when the addition of the description has been set by the second setting section;
a second registration section for adding the description input by the input section to the image registered in the first registration section, and registering the resultant image; and
a control section for performing a control for displaying on the display the registered image and description after the image with the added description has been registered in the second registration section.

13. An image forming apparatus according to claim 12, wherein the first registration section includes a designation section for designating an advertisement time and a priority level of the image to be registered, and a first process section for performing an accounting process for the image to be registered, in accordance with the advertisement time and priority level designated by the designation section.

14. An image forming apparatus according to claim 12 or 13, wherein the second registration section includes a second process section for performing an accounting process in accordance with a length of the description input by the input section and the advertisement time designated by the designation section.

15. An image forming apparatus for forming an image by controlling an image forming operation, the apparatus comprising:
a display for displaying information;
an operation panel for setting registration for displaying a message on the display;
an input section for inputting a message to be registered, when the registration for displaying the message has been set by the operation panel;
a registration section for registering the message input by the input section; and
a control section for performing a control for displaying on the display the message registered in the registration section.

16. An image forming apparatus according to claim 15, wherein the input section includes a first determination section for determining whether the input of the message is permitted, using pre-registered identification information and a password associated therewith.

17. An image forming apparatus according to claim 15, wherein the input section includes a second determination section for determining whether the display of the message is permitted, using pre-registered identification information and a password associated therewith.
